(19) United States
(12) Patent Application Publication
(10) Pub. No.: US 2023/0238562 A1
(43) Pub. Date: Jul. 27, 2023

(54) SYSTEMS AND METHODS FOR HIGH PRESSURE ASSEMBLY OF ELECTROCHEMICAL CELLS

(71) Applicant: 24M Technologies, Inc., Cambridge, MA (US)

(72) Inventors: Yuki KUSACHI, Burlington, MA (US); Junzheng CHEN, Concord, MA (US); Naoki OTA, Lexington, MA (US); Bradley Richard MILESON, Somerville, MA (US); Matthew Bonju LIM, Somerville, MA (US); Ryan Michael LAWRENCE, Cambridge, MA (US)

(21) Appl. No.: 18/101,323

(22) Filed: Jan. 25, 2023

Related U.S. Application Data
(60) Provisional application No. 63/302,622, filed on Jan. 25, 2022.

(51) Int. Cl. H01M 10/04

(52) U.S. Cl. CPC H01M 10/0404; H01M 2010/4292

(57) ABSTRACT

Embodiments described herein relate to electrochemical cells and production thereof under high pressure. In some aspects, a method of producing an electrochemical cell can include disposing a cathode material onto a cathode current collector to form a cathode, disposing an anode material onto an anode current collector to form an anode, and disposing the anode onto the cathode in an assembly jig with a separator positioned between the anode and the cathode to form an electrochemical cell, the assembly jig applying a force to the electrochemical cell such that a pressure in the cathode material is at least about 3,500 kPa. In some embodiments, the cathode material can be a first cathode material, and the method can further include disposing a second cathode material onto the first cathode material. In some embodiments, the first cathode material can include silicon. In some embodiments, the second cathode material can include graphite.

### CROSS REFERENCE TO RELATED APPLICATIONS

This application claims the benefit of U.S. Provisional Application No. 63/302,622, titled, “Systems and Methods for High Pressure Assembly of Electrochemical Cells,” and filed Jan. 25, 2022, the content of which is incorporated herein by reference in its entirety.

### TECHNICAL FIELD

Embodiments described herein relate to production of electrochemical cells under high pressures.

### BACKGROUND

Electrochemical cells can be produced with multiple layers in the anode and/or the cathode. However, gas can form and build up during formation of the electrochemical cell. Gas can form in the electrodes, at interfaces between the electrode layers, or electrodes and separators. A solid-electrolyte interface (SEI) can also build up between layers of the electrochemical cell. This can lead to capacity loss both during the initial cycling of the cell and through later cycling of the cell. By inhibiting the ability for gas bubbles and SEI to form, cell performance and cycling stability can be improved.

### SUMMARY

Embodiments described herein relate to electrochemical cells and production thereof under high pressure. In some aspects, a method of producing an electrochemical cell can include disposing a cathode material onto a cathode current collector to form a cathode, disposing an anode material onto an anode current collector to form an anode, and disposing the anode onto the cathode in an assembly jig with a separator positioned between the anode and the cathode to form an electrochemical cell, the assembly jig applying a force to the electrochemical cell such that a pressure in the cathode material is at least about 3,500 kPa. In some embodiments, the cathode material can be a first cathode material, and the method can further include disposing a second cathode material onto the first cathode material. In some embodiments, the first cathode material can include silicon. In some embodiments, the second cathode material can include graphite. In some embodiments, the assembly jig can apply a force to the electrochemical cell such that the pressure in the cathode material is at least about 7,000 kPa or at least about 8,000 kPa.

### BRIEF DESCRIPTION OF THE DRAWINGS

FIG. 1 is a block diagram of a method of producing an electrochemical cell, according to an embodiment.

FIG. 2 is a block diagram of an assembly jig for producing an electrochemical cell, according to an embodiment.

FIGS. 3A-3D are illustrations of an assembly jig for producing an electrochemical cell, according to an embodiment.

FIG. 4 is an illustration of an assembly jig for producing an electrochemical cell, according to an embodiment.

FIGS. 5A-5D are illustrations of an electrochemical cell stack produced with an assembly jig, according to an embodiment.

FIGS. 6A-6C are illustrations of a method for incorporating a current collector to an electrochemical cell, according to an embodiment.

FIGS. 7A-7C are illustration a method for incorporating a current collector to an electrochemical cell, according to an embodiment.

FIGS. 8A-8B show capacity retention of electrochemical cells constructed and operated at various pressures.

### DETAILED DESCRIPTION

Embodiments described herein relate to electrochemical cells and production thereof. Some electrochemical cells described herein can include electrodes with multiple layers. Electrochemical cells with multi-layered electrodes are described in greater detail in U.S. Patent Publication No. 2019/0363351 (“the '351 publication”), filed May 24, 2019 and titled, “High Energy-Density Composition-Gradient Electrodes and Methods of Making the Same,” the disclosure of which is hereby incorporated by reference in its entirety. Some multi-layered electrodes comprise a first layer that includes silicon and a second layer that includes graphite. For example, such an electrode can include a silicon-graphite interface. Silicon and graphite particles can contact one another. Gas bubbles can form between these electrode layers, thereby preventing or at least partially inhibiting contact between the electrode layers. SEI layers can form during formation and initial cycling of the cells. These gas bubbles and SEI layers can be at least partially mitigated by pressurizing the electrochemical cell and the layers of the electrodes during formation of the electrochemical cell. In some embodiments, the pressurizing can be via an assembly jig. By increasing the pressure during formation, gas bubbles and SEI layers have less space, in which to form.

In some embodiments, electrodes described herein can include conventional solid electrodes. In some embodiments, the solid electrodes can include binders. In some embodiments, electrodes described herein can include semi-solid electrodes. Semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can be a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid suspensions are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

As used herein, the terms “activated carbon network” and “networked carbon” relate to a general qualitative state of an electrode. For example, an electrode with an activated carbon network (or networked carbon) is such that the carbon particles within the electrode assume an individual particle morphology and arrangement with respect to each other that facilitates electrical contact and electrical conductivity between particles and through the thickness and length of the electrode. Conversely, the terms “unactivated carbon network” and “unnetworked carbon” relate to an electrode wherein the carbon particles either exist as individual particle islands or multi-particle agglomerate islands that may not be sufficiently connected to provide adequate electrical conduction through the electrode.

As used herein, the terms “energy density” and “volumetric energy density” refer to the amount of energy (e.g., MJ) stored in an electrochemical cell per unit volume (e.g., L) of the materials included for the electrochemical cell to operate such as, the electrodes, the separator, the electrolyte, and the current collectors. Specifically, the materials used for packaging the electrochemical cell are excluded from the calculation of volumetric energy density.

As used herein, the terms “high-capacity materials” or “high-capacity anode materials” refer to materials with irreversible capacities greater than 300 mAh/g that can be incorporated into an electrode in order to facilitate uptake of electroactive species. Examples include tin, tin alloy such as Sn—Fe, tin mono oxide, silicon, silicon alloy such as Si—Co, silicon monoxide, aluminum, aluminum alloy, mono oxide metal (CoO, FeO, etc.) or titanium oxide.

As used herein, the term “composite high-capacity electrode layer” refers to an electrode layer with both a high-capacity material and a traditional anode material, e.g., a silicon-graphite layer.

As used herein, the term “solid high-capacity electrode layer” refers to an electrode layer with a single solid phase high-capacity material, e.g., sputtered silicon, tin, tin alloy such as Sn—Fe, tin mono oxide, silicon, silicon alloy such as Si—Co, silicon monoxide, aluminum, aluminum alloy, mono oxide metal (CoO, FeO, etc.) or titanium oxide.

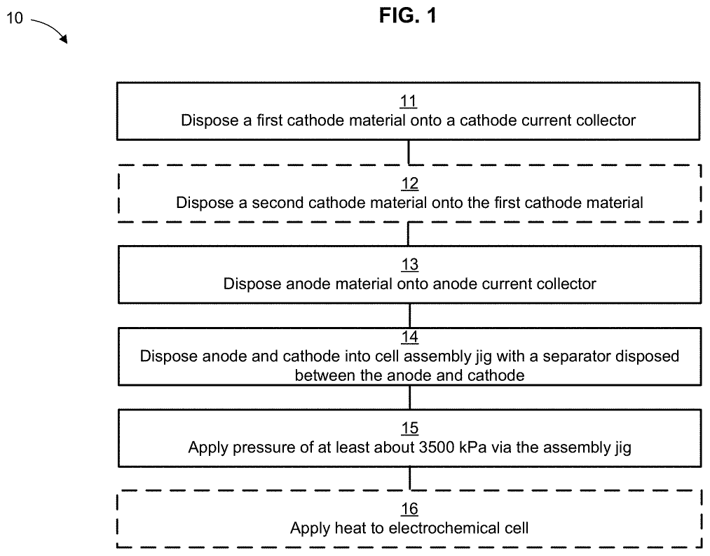

FIG. 1 is a block diagram of a method 10 of producing an electrochemical cell, according to an embodiment. As shown, the method 10 includes disposing a first cathode material onto a cathode current collector at step 11. The method 10 optionally includes disposing a second cathode material onto the first cathode material at step 12. The method 10 further includes disposing an anode material onto an anode current collector at step 13, disposing the anode and the cathode into a cell assembly jig with a separator disposed between the anode and the cathode to form an electrochemical cell at step 14, and applying a pressure of at least about 3,500 kPa to the electrochemical cell at step 15. The method 10 optionally includes applying heat to the electrochemical cell at step 16.

Step 11 includes disposing a first cathode material onto the cathode current collector to form a cathode. In some embodiments, the first cathode material can include a semi-solid cathode material. In some embodiments, the first cathode material can include a solid or conventional electrode material. In some embodiments, the first cathode material can include silicon. In some embodiments, the first cathode material can include graphite. In some embodiments, the first cathode material can include any of the electrode materials described in the '351 publication.

Step 12 is optional and includes disposing a second cathode material onto the first cathode material. In some embodiments, the second cathode material can include a semi-solid cathode material. In some embodiments, the second cathode material can include a solid or conventional electrode material. In some embodiments, the second cathode material can include silicon. In some embodiments, the second cathode material can include graphite. In some embodiments, the second cathode material can include any of the electrode materials described in the '351 publication.

Step 13 includes disposing an anode material onto an anode current collector to form an anode. In some embodiments, the anode material can include a semi-solid anode material. In some embodiments, the anode material can include a solid or conventional electrode material. In some embodiments, the anode material can include silicon. In some embodiments, the anode material can include graphite. In some embodiments, the anode material can include any of the electrode materials described in the '351 publication.

Step 14 includes disposing the anode and the cathode into a cell assembly jig with a separator positioned between the anode and the cathode. In some embodiments, the separator can be placed between the anode and the cathode prior to placing the anode and the cathode into the cell assembly jig. In some embodiments, the separator can be placed between the anode and the cathode after placing the anode and the cathode into the cell assembly jig. In some embodiments, the anode, the cathode, and the separator can be placed into the cell assembly jig with the anode on top. In some embodiments, the anode, the cathode, and the separator can be placed into the cell assembly jig with the cathode on top.

Step 15 includes applying a pressure to the anode, the cathode, and the separator of at least about 3,500 kPa via the assembly jig. In some embodiments, the pressure applied can be measured based on a pressure in the cathode. In some embodiments, the pressure applied can be measured based on a pressure in the anode. In some embodiments, the cell assembly jig can include springs for implementation of pressure.

In some embodiments, the pressure applied by the cell assembly jig can be at least about 3,500 kPa, at least about 4,000 kPa, at least about 4,500 kPa, at least about 5,000 kPa, at least about 5,500 kPa, at least about 6,000 kPa, at least about 6,500 kPa, at least about 7,000 kPa, at least about 7,500 kPa, at least about 8,000 kPa, at least about 8,500 kPa, at least about 9,000 kPa, at least about 9,500 kPa, at least about 10,000 kPa, at least about 10,500 kPa, at least about 11,000 kPa, at least about 11,500 kPa, at least about 12,000 kPa, at least about 12,500 kPa, at least about 13,000 kPa, at least about 13,500 kPa, at least about 14,000 kPa, or at least about 14,500 kPa. In some embodiments, the pressure applied by the cell assembly jig can be no more than about 15,000 kPa, no more than about 14,500 kPa, no more than about 14,000 kPa, no more than about 13,500 kPa, no more than about 13,000 kPa, no more than about 12,500 kPa, no more than about 12,000 kPa, no more than about 11,500 kPa, no more than about 11,000 kPa, no more than about 10,500 kPa, no more than about 10,000 kPa, no more than about 9,500 kPa, no more than about 9,000 kPa, no more than about 8,500 kPa, no more than about 8,000 kPa, no more than about 7,500 kPa, no more than about 7,000 kPa, no more than about 6,500 kPa, no more than about 6,000 kPa, no more than about 5,500 kPa, no more than about 5,000 kPa, no more than about 4,500 kPa, or no more than about 4,000 kPa. Combinations of the above-referenced pressures are also possible (e.g., at least about 3,500 kPa and no more than about 15,000 kPa or at least about 5,000 kPa and no more than about 10,000 kPa), inclusive of all values and ranges therebetween. In some embodiments, the pressure applied by the cell assembly jig can be about 3,500 kPa, about 4,000 kPa, about 4,500 kPa, about 5,000 kPa, about 5,500 kPa, about 6,000 kPa, about 6,500 kPa, about 7,000 kPa, about 7,500 kPa, about 8,000 kPa, about 8,500 kPa, about 9,000 kPa, about 9,500 kPa, about 10,000 kPa, about 10,500 kPa, about 11,000 kPa, about 11,500 kPa, about 12,000 kPa, about 12,500 kPa, about 13,000 kPa, about 13,500 kPa, about 14,000 kPa, about 14,500 kPa, or about 15,000 kPa.

In some embodiments, the cell assembly jig can apply a force of at least about 100 N, at least about 200 N, at least about 300 N, at least about 400 N, at least about 500 N, at least about 600 N, at least about 700 N, at least about 800 N, at least about 900 N, at least about 1,000 N, at least about 1,100 N, at least about 1,200 N, at least about 1,300 N, at least about 1,400 N, at least about 1,500 N, at least about 1,600 N, at least about 1,700 N, at least about 1,800 N, at least about 1,900 N, at least about 2,000 N, at least about 2,100 N, at least about 2,200 N, at least about 2,300 N, or at least about 2,400 N. In some embodiments, the cell assembly jig can apply a force of no more than about 2,500 N, no more than about 2,400 N, no more than about 2,300 N, no more than about 2,200 N, no more than about 2,100 N, no more than about 2,000 N, no more than about 1,900 N, no more than about 1,800 N, no more than about 1,700 N, no more than about 1,600 N, no more than about 1,500 N, no more than about 1,400 N, no more than about 1,300 N, no more than about 1,200 N, no more than about 1,100 N, no more than about 1,000 N, no more than about 900 N, no more than about 800 N, no more than about 700 N, no more than about 600 N, no more than about 500 N, no more than about 400 N, no more than about 300 N, or no more than about 200 N.

Combinations of the above-referenced forces are also possible (e.g., at least about 100 N and no more than about 2,500 N or at least about 500 N and no more than about 1,500 N), inclusive of all values and ranges therebetween. In some embodiments, the cell assembly jig can apply a force of about 100 N, about 200 N, about 300 N, about 400 N, about 500 N, about 600 N, about 700 N, about 800 N, about 900 N, about 1,000 N, about 1,100 N, about 1,200 N, about 1,300 N, about 1,400 N, about 1,500 N, about 1,600 N, about 1,700 N, about 1,800 N, about 1,900 N, about 2,000 N, about 2,100 N, about 2,200 N, about 2,300 N, about 2,400 N, or about 2,500 N. In some embodiments, the force can be applied vertically. In some embodiments, the force can be applied horizontally. In some embodiments, the force can be applied an angle relative to the vertical (e.g., about 10°, about 20°, about 30°, about 40°, about 45°, about 50°, about 60°, about 70°, or about 80°, inclusive of all values and ranges therebetween). In other words, the jig can be rotated relative to the vertical when the force is applied to the electrochemical cell.

Step 16 is optional and includes applying heat to the electrochemical cell. In some embodiments, applying heat can aid in expulsion of gases during the pressurization. In some embodiments, the heat applied is in an amount sufficient to vaporize binder that has migrated to an interface between the first cathode material and the cathode current collector. In some embodiments, the heat applied is in an amount sufficient to vaporize binder that has migrated to an interface between the anode material and the anode current collector. In some embodiments, the heat applied is in an amount sufficient to vaporize binder that has migrated to an interface between the first cathode material and the second cathode material. In some embodiments, the heat can be applied via a neodymium-doped yttrium aluminum garnet (Nd:YAG) laser, a CO₂ laser, electron beam irradiation, plasma, corona, deep ultraviolet (UV), etching, infrared, a hot plate, a hot roll, steaming, sputtering, Cu/C sputtering, and/or direct fire burning. In some embodiments, the electrochemical cell can be heated to a temperature of at least about 30° C., at least about 35° C., at least about 40° C., at least about 45° C., at least about 50° C., at least about 55° C., at least about 60° C., at least about 65° C., at least about 70° C., at least about 75° C., at least about 80° C., at least about 85° C., at least about 90° C., at least about 95° C., at least about 100° C., at least about 105° C., at least about 110° C., at least about 115° C., at least about 120° C., at least about 125° C., at least about 130° C., at least about 135° C., at least about 140° C., at least about 145° C., or at least about 150° C.

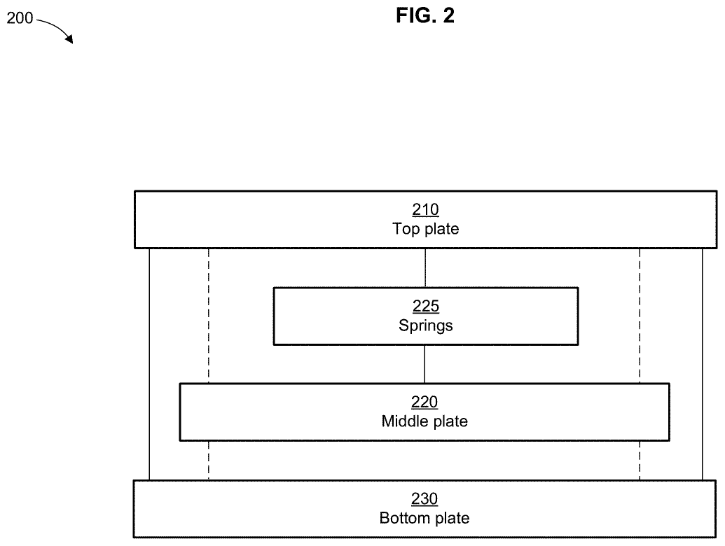

FIG. 2 is a block diagram of an assembly jig 200 for assembling an electrochemical cell, according to an embodiment. As shown, the assembly jig 200 includes a top plate 210, a middle plate 220, and a bottom plate 230, with springs 225 disposed between the top plate 210 and the middle plate 220. The top plate 210 is coupled to the bottom plate 230. The top plate 210 is also coupled to the springs 225. The middle plate 220 is coupled to the springs 225. In some embodiments, the top plate 210 can be coupled to the middle plate 220. In some embodiments, the middle plate 220 can be coupled to the bottom plate 230.

In some embodiments, the top plate 210, the middle plate 220, and/or the bottom plate 230 can be composed of metal, ceramic, wood, plastic, a polymer, polyethylene, polypropylene, or any other suitable material or combinations thereof. In some embodiments, the top plate 210 can include grooves or indentations for the springs 225 to rest. In some embodiments, the middle plate 220 can be fastened to the top plate 210 via fasteners (e.g., screws, bolts, anchors, nuts, nails, rivets, or any combination thereof). In some embodiments, the middle plate 220 can be fastened to the bottom plate 230 via fasteners. In some embodiments, fasteners coupling the top plate 210 to the middle plate 220 can be the same fasteners as those coupling the middle plate 220 to the bottom plate 230. In some embodiments, fasteners can connect the top plate 210 directly to the bottom plate 230 and be positioned through unthreaded holes in the middle plate 220.

The springs 225 provide a force to pressurize an electrochemical cell between the middle plate 220 and the bottom plate 230. Tightness of fasteners can be adjusted to change the force applied to the cells. For example, tightening each of the fasteners by a quarter turn can increase the pressure in the electrochemical cell by about 50 to 100 kPa. The bottom plate 230 provides support for the electrochemical cell, as the electrochemical cell is placed between the bottom plate 230 and the middle plate 220. In some embodiments, each of the fasteners can be tightened simultaneously. In some embodiments, the fasteners can be tightened at alternating intervals (e.g., a first fastener is tightened, then a second fastener is tightened, etc.)

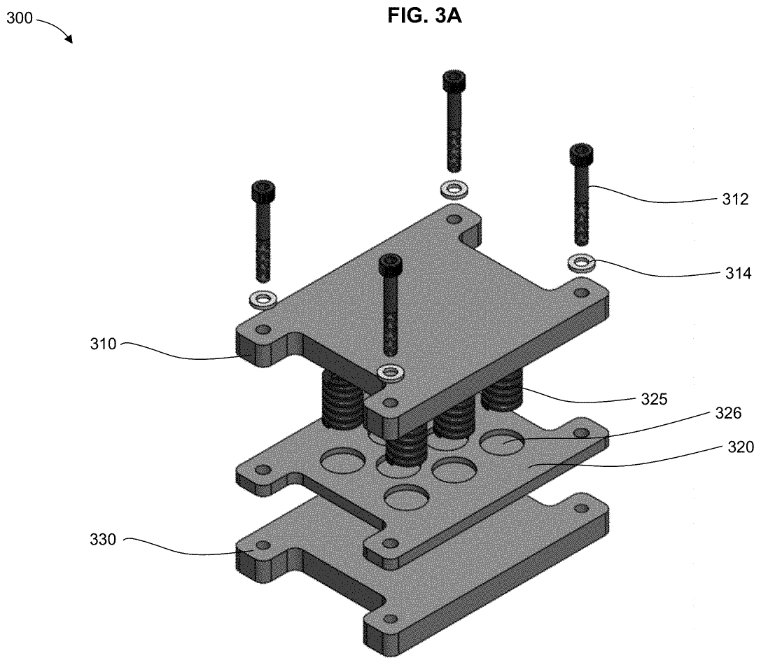

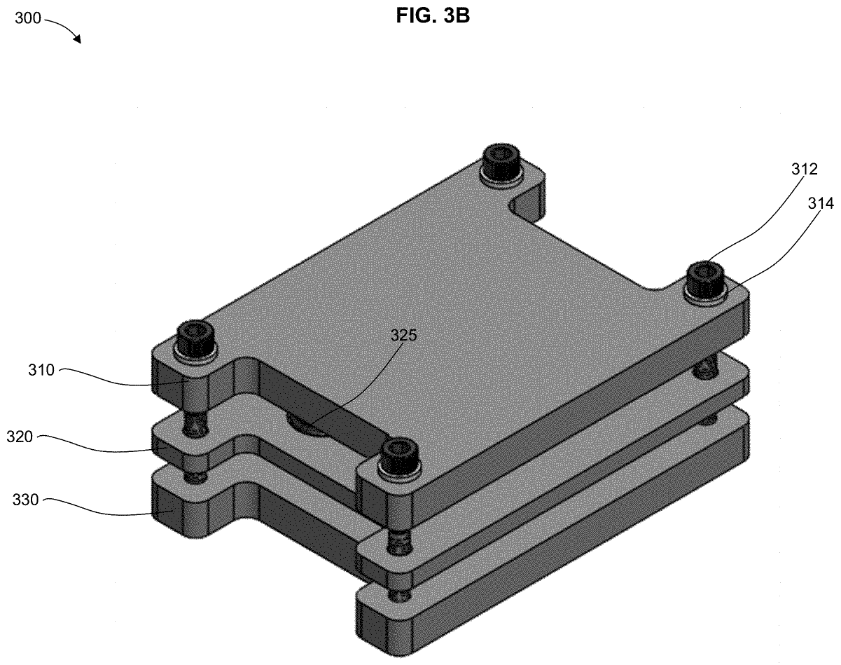

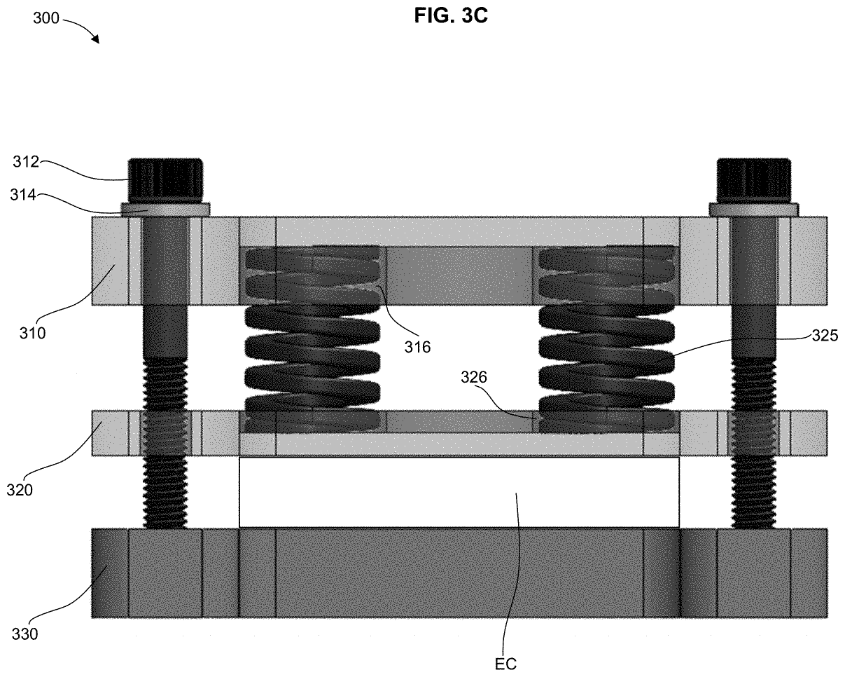

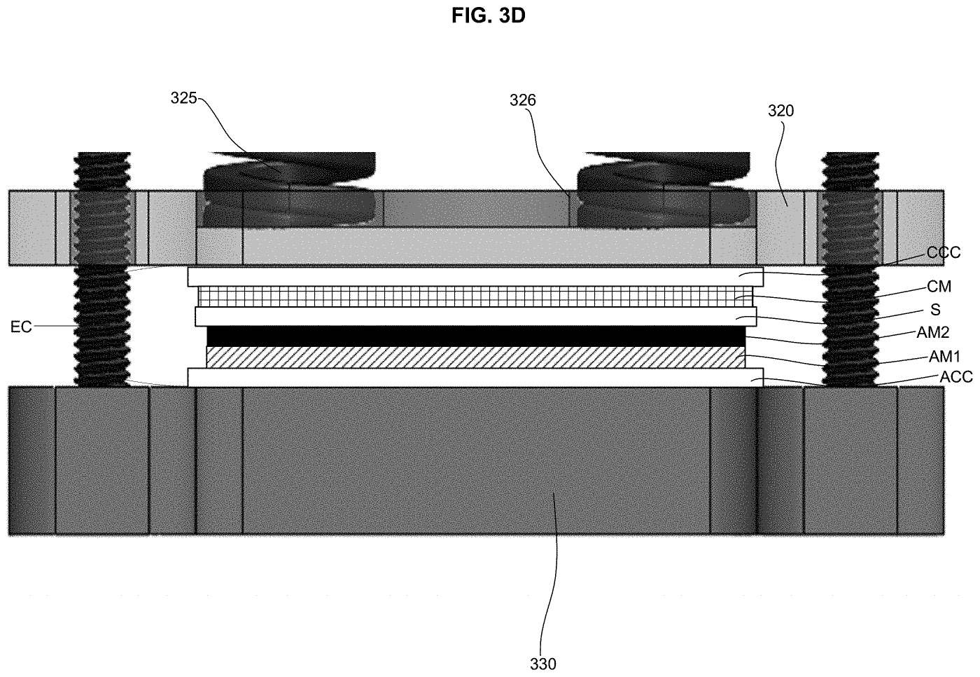

FIGS. 3A-3D are illustrations of an assembly jig 300 for producing an electrochemical cell EC, according to an embodiment. As shown, the assembly jig 300 includes a top plate 310, a middle plate 320, and a bottom plate 330, with springs 325 disposed between the top plate 310 and the middle plate 320. In some embodiments, the top plate 310, the middle plate 320, the springs 325, and the bottom plate 330 can be the same or substantially similar to the top plate 210, the middle plate 220, the springs 225, and the bottom plate 230, as described above with reference to FIG. 2. Thus, certain aspects of the top plate 310, the middle plate 320, the springs 325, and the bottom plate 330 are not described in greater detail herein. FIG. 3A shows an auxiliary view of the assembly jig 300 with the parts separated to show detail. FIG. 3B shows an auxiliary view of the assembly jig 300 with the parts assembled. FIG. 3C shows a cross-sectional view of the assembly jig 300, such that details of the springs 325 are visible. FIG. 3D is a view of the electrochemical cell EC in the assembly jig 300.

The assembly jig 300 includes fasteners 312 for coupling the top plate 310 to the bottom plate 330 and/or the middle plate 320. The fasteners 312 can be tightened or loosened to induce the desired pressure in the electrochemical cell EC. Washers 314 can be placed between the fasteners 312 and the top plate 310 to protect the top plate 310 and disperse the load applied upon tightening the fasteners 312. As shown, the assembly jig 300 includes 4 fasteners 312. In some embodiments, the assembly jig 300 can include 2, 3, 4, 5, 6, 7, 8, 9, 10, 11, 12, 13, 14, 15, 16, 17, 18, 19, 20, or at least about 20 fasteners 312, inclusive of all values and ranges therebetween. As shown, a first set of fasteners 312 is threaded through the top plate 310 and fastened to threads in the bottom plate 330. The fasteners 312 are shown running through the middle plate 320 without being threaded in the middle plate 320. In some embodiments, the fasteners 312 can be threaded to the middle plate 320.

As shown, the top plate 310 includes indentations 316 for placement of the springs 325. In some embodiments, the top plate 310 can be bonded to the springs 325 (e.g., via welding and/or an adhesive). The middle plate 320 is shown without threading. In other words, the threads of the fasteners go through the middle plate 320 without being directly fastened to them. As shown, the middle plate 320 includes indentations 326 for placement of the springs 325. In some embodiments, the middle plate 320 can be bonded to the springs 325 (e.g., via welding and/or an adhesive). As shown, the assembly jig 300 includes 8 springs 325. In some embodiments, the assembly jig 300 can include 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, or at least about 40 springs 325, inclusive of all values and ranges therebetween.

FIG. 3D shows the electrochemical cell EC between the middle plate 320 and the bottom plate 330. As shown, the electrochemical cell EC includes an anode current collector ACC with a first anode material AM1, a cathode current collector CCC with cathode material CM disposed thereon. A second anode material AM2 is disposed on the first anode material AM1, and a separator S is disposed between the cathode material CM and the second anode material AM2. As shown, the anode includes multiple layers. In some embodiments, the cathode can include multiple layers. In some embodiments, the anode and the cathode can include multiple layers. In some embodiments, neither the anode nor the cathode can include multiple layers. Initial cycling of the electrochemical cell EC can be run with the electrochemical cell EC disposed in the jig and subject to the desired pressure. In some embodiments, 1, 2, 3, 4, 5, 6, 7, 8, 9, 10, 11, 12, 13, 14, 15, 16, 17, 18, 19, 20, or at least about 20 initial cycles can be run while the electrochemical cell EC is under the desired pressure, inclusive of all values and ranges therebetween. As shown, the springs 325 are above the electrochemical cell EC. In some embodiments, the springs 325 can be positioned below the electrochemical cell EC and press upward. As shown, a single electrochemical cell EC is placed in the assembly jig 300. In some embodiments, 1, 2, 3, 4, 5, 6, 7, 8, 9, 10, 11, 12, 13, 14, 15, 16, 17, 18, 19, 20, or at least about 20 electrochemical cells can be stacked upon each other in the assembly jig 300.

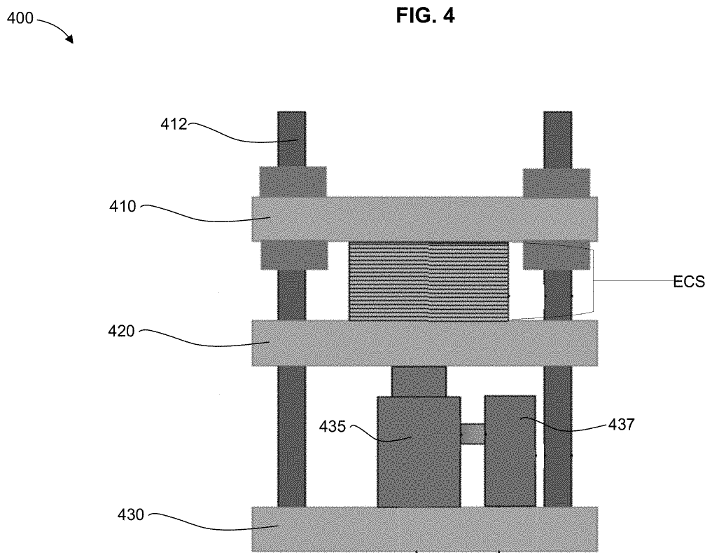

FIG. 4 is an illustration of an assembly jig 400 for producing an electrochemical cell stack ECS (or a single electrochemical cell), according to an embodiment. As shown, the assembly jig 400 includes a top plate 410, a middle plate 420, and a bottom plate 430, with fasteners 412 securing the plates together. In some embodiments, the top plate 410, the fasteners 412, the middle plate 420, the bottom plate 430 can be the same or substantially similar to the top plate 310, the fasteners 312, the middle plate 320, and the bottom plate 330, as described above with reference to FIGS. 3A-3D. Thus, certain aspects of the top plate 410, the fasteners 412, the middle plate 420, the bottom plate 430 are not described in greater detail herein.

A hydraulic ram 435 is placed between the middle plate 420 and the bottom plate 430 and supplies a pressure to the electrochemical cell stack ECS by pressing upward against the middle plate 420. An air-to-hydraulic multiplier 437 is fluidically coupled to the hydraulic ram 435. In some embodiments, the air-to-hydraulic multiplier 437 can include a hydraulic pump. In some embodiments, the air-to-hydraulic multiplier 437 can be operated manually (i.e., by hand). In some embodiments, the air-to-hydraulic multiplier 437 can be operated by electric power, gas power, or any other suitable power generation method. In some embodiments, the air-to-hydraulic multiplier 437 can be automated. In some embodiments, the air-to-hydraulic multiplier 437 can be operated by computer. As shown, the hydraulic ram 435 and the air-to-hydraulic multiplier 437 are placed below the middle plate 420 and push upward to apply a force to the electrochemical cell stack ECS. In some embodiments, the hydraulic ram 435 and the air-to-hydraulic multiplier 437 can be placed above the middle plate 420 and push downward to apply a force to the electrochemical cell stack ECS, with the electrochemical cell stack ECS placed between the middle plate 420 and the bottom plate 430.

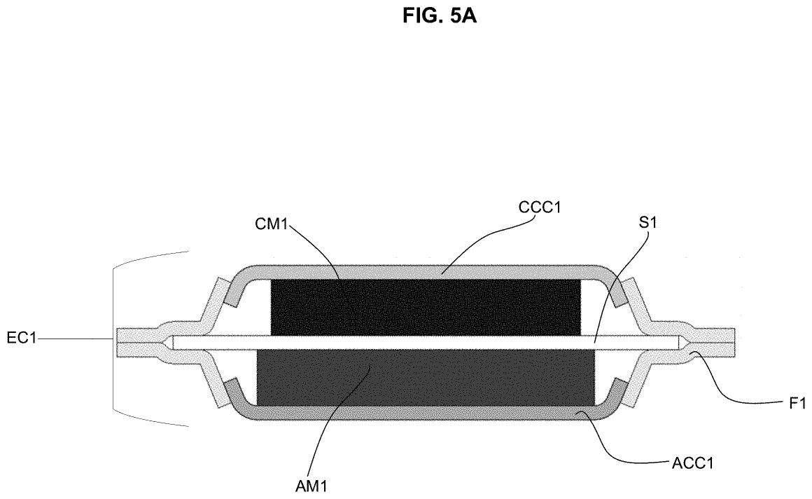

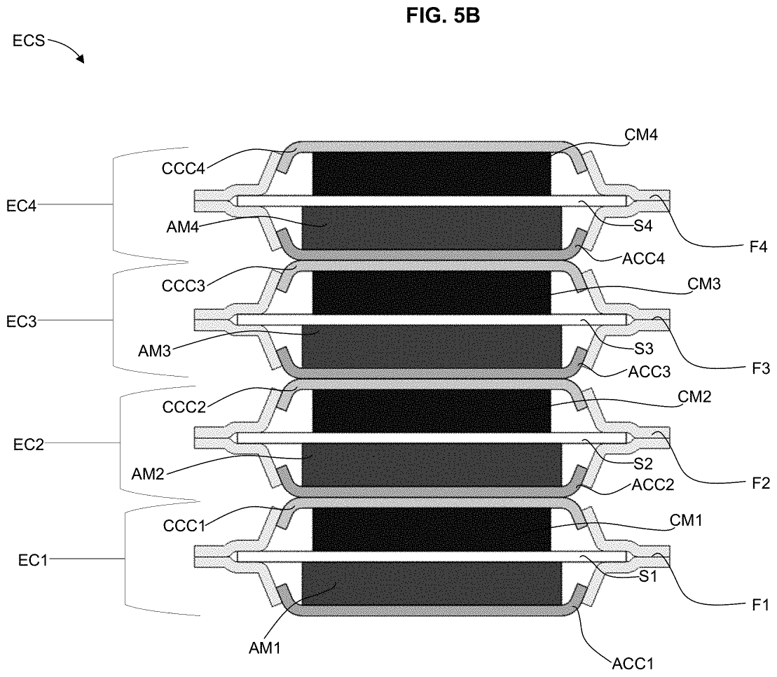

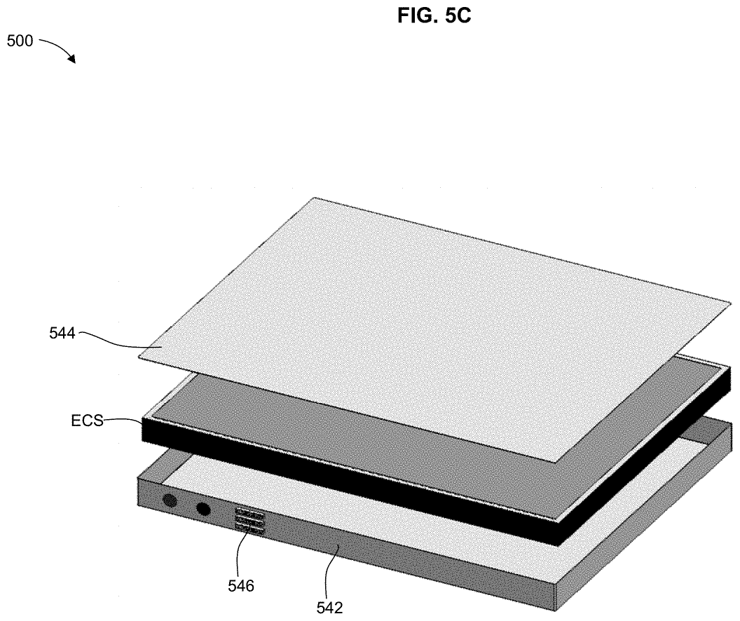

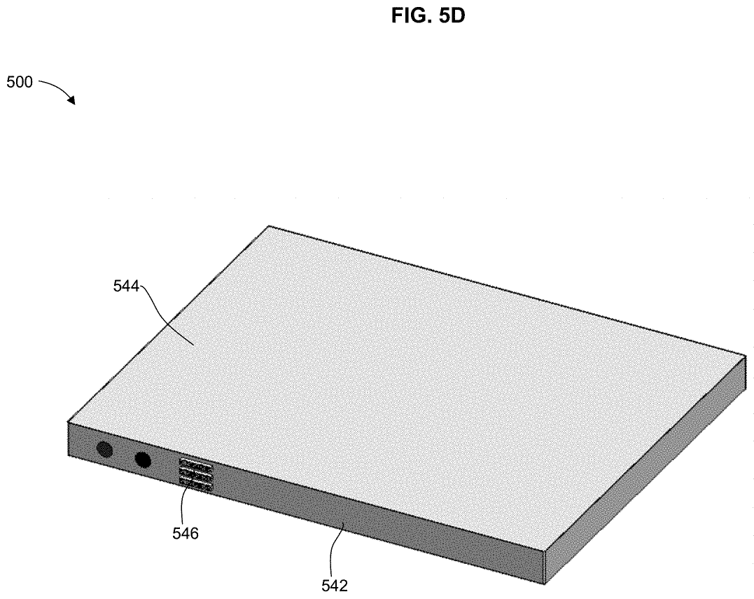

FIGS. 5A-5D are illustrations of an electrochemical cell stack produced with an assembly jig, according to an embodiment. FIG. 5A shows a single electrochemical cell EC1, while FIG. 5B shows multiple electrochemical cells EC1, EC2, EC3, EC4 stacked together to form an electrochemical cell stack ECS. FIG. 5C shows an apparatus 500 that includes the electrochemical cell stack ECS inside a case 542 with a cover 544 placed thereon (exploded view). FIG. 5D shows the apparatus 500 in its completed form.

As shown in FIGS. 5A and 5B, each of the electrochemical cells EC1, EC2, EC3, EC4 (collectively referred to as electrochemical cells EC) includes anode materials AM1, AM2, AM3, AM4 (collectively referred to as anode materials AM), anode current collectors ACC1, ACC2, ACC3, ACC4 (collectively referred to as anode current collectors ACC), cathode materials CM1, CM2, CM3, CM4 (collectively referred to as cathode materials CM), cathode current collectors CCC1, CCC2, CCC3, CCC4 (collectively referred to as cathode current collectors CCC), separators S1, S2, S3, S4 (collectively referred to as separators S), and films F1, F2, F3, F4 (collectively referred to as films F). As shown, the films F form a partial pouch but do not fully cover the anode current collectors ACC or the cathode current collectors CCC. The cathode current collector CCC1 physically contacts the anode current collector ACC2, the cathode current collector CCC2 physically contacts the anode current collector ACC3, and so on. As shown, the electrochemical cells ECC are arranged in series. In some embodiments, the voltage measured from the anode current collector ACC1 to the anode current collector ACC3 can be about double the voltage measured from the anode current collector ACC1 to the anode current collector ACC2. As an example, the voltage measured from anode current collector ACC1 to anode current collector ACC2 can be about 3.6 V, the voltage measured from anode current collector ACC1 to anode current collector ACC3 can be about 7.2 V, the voltage measured from anode current collector ACC1 to anode current collector ACC4 can be about 10.8 V, and the voltage measured from anode current collector ACC1 to cathode current collector CCC4 can be about 14.4 V. In some embodiments, the electrochemical cell stack ECS can be arranged in parallel. As shown, the electrochemical cell stack ECS includes four electrochemical cells EC. In some embodiments, the electrochemical cell stack ECS can include 1, 2, 3, 4, 5, 6, 7, 8, 9, 10, 11, 12, 13, 14, 15, 16, 17, 18, 19, 20, or at least about 20 electrochemical cells EC. In some embodiments, each of the electrochemical cells EC can have the same battery chemistry. In some embodiments, the electrochemical cells EC can have varying battery chemistries.

Application of high pressure during production of the electrochemical cell stack ECS can be very beneficial for performance. By applying a pressure during production of the electrochemical cell stack ECS, contact between adjacent anode current collectors and cathode current collectors (e.g., anode current collector ACC2 and cathode current collector CCC1) can be improved and gas bubbles can be removed from the anode materials AM and/or the cathode materials CM. This can improve capacity retention and efficiency of the electrochemical cells EC.

FIG. 5C shows the electrochemical cell stack ECS being loaded into the case 542 with a cover placed thereon. As shown, the case 542 includes a voltage monitor 546 integrated therein. In some embodiments, the voltage monitor 546 can monitor voltage drop across each of the electrochemical cells EC. FIG. 5D shows the apparatus 500 in its assembled form, with the electrochemical cell stack ECS inside the case 542.

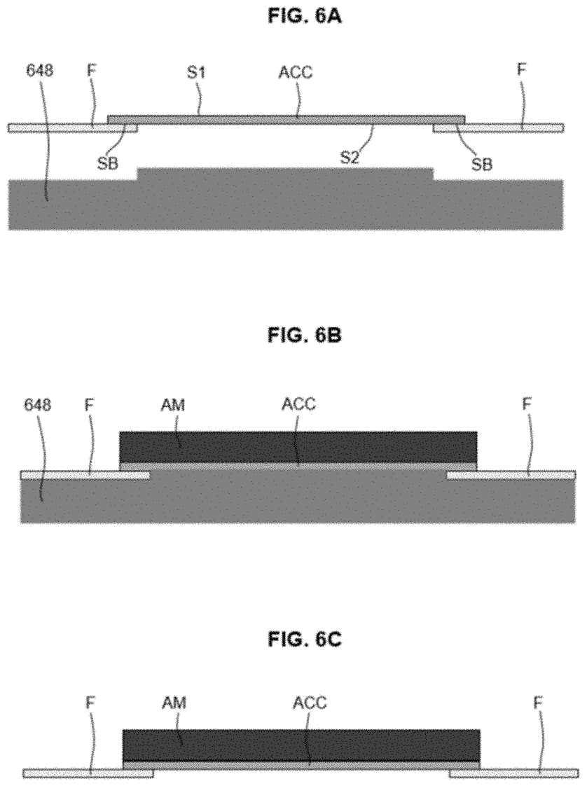

FIGS. 6A-6C illustrate a method for incorporating a current collector to an electrochemical cell EC, according to an embodiment. The electrochemical cell EC can be similar to and/or the same as of the electrochemical cell included in an electrochemical stack disclosed herein (e.g., the electrochemical cells EC1, EC2, EC3, or EC4). The current collector can be an anode current collector or a cathode current collector. FIG. 6A illustrates an example anode current collector foil ACC can be attached and/or coupled to a film F via a pre-lamination step. The pre-lamination step can be any suitable lamination procedure in which a first material (e.g., the anode current collector foil ACC) is disposed adjacent to and in contact with a second material (e.g., the film F), and heat and/or pressure is applied to facilitate and/or promote the adhesion of the two materials at their interface and formation of lamination bonds. FIG. 6A shows the pre-lamination step can introduce strong (e.g., permanent) lamination bonds (SB) on selected areas of the anode current collector ACC in contact with the film F, while leaving the exposed surfaces S1 and S2 on each side of the anode current collector ACC. The anode current collector ACC pre-laminated to the film F can be placed on a contoured casting pallet 648 which includes a protrusion shaped and sized to match the dimensions of the exposed surface S2. FIG. 6B shows an anode electrode material (AM) can then be casted on the anode current collector ACC. Alternatively and/or optionally, in some embodiments more than one anode material (AM) can be casted on the anode current collector ACC (e.g., a first anode material AM1 can be casted on the anode current collector ACC and then a second anode material AM2 can be casted over the first anode material AM1). FIG. 6C shows the anode current collector ACC with the casted anode material AM can then be removed from the contoured casting pallet 648 producing an electrode with a consistent electrode coating thickness and an open surface S2 that can be used to make electrical connections when stacking multiple electrochemical cells.

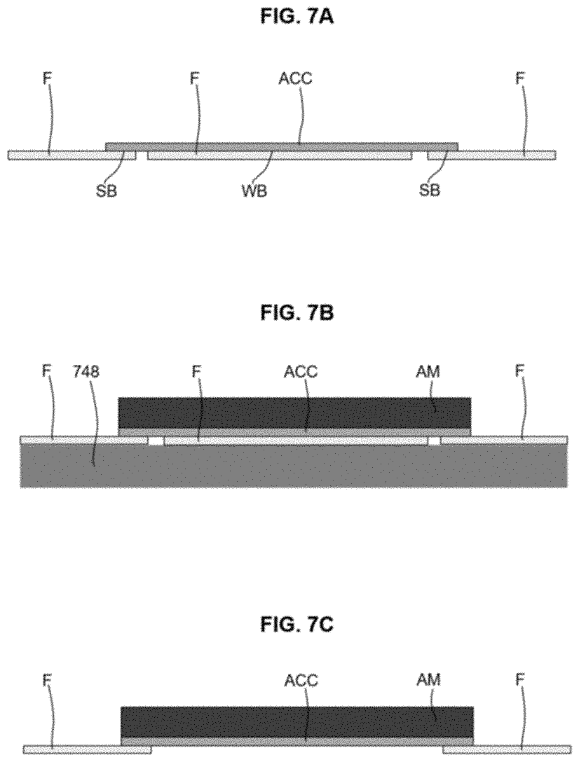

FIGS. 7A-7C illustrate a method for incorporating a current collector to an electrochemical cell EC, according to another embodiment. Similar to the method described in FIGS. 6A-6C, the electrochemical cell EC can be any suitable electrochemical cell included in an electrochemical stack (e.g., the electrochemical cells EC1, EC2, EC3, or EC4), and the current collector can be either an anode current collector or a cathode current collector. FIG. 7A shows an example anode current collector foil ACC which has been attached and/or coupled to a film F in a pre-lamination step. During the pre-lamination step the anode current collector ACC has been attached to the film F by creating and/or generating two different types of contact areas and/or junctions between the two materials. In the first type of contact area the anode current collector ACC has been laminated to the film F producing strong bonds (SB). The strong bonds (SB) are intended to produce a permanent joint between the anode current collector ACC and the film F. In the second type of contact area the anode current collector ACC has been laminated to the film F producing weak bonds (WB). The weak bonds (WB) are intended to produce a temporary joint (e.g., a removable joint) between the anode current collector ACC and the film F. A small perforation or gap separates the contact areas with permanent joints from the contact areas with temporary joints. FIG. 7B shows the anode current collector ACC pre-laminated to the film F can be placed in a flat casting pallet 748. An anode electrode material (AM) can then be casted on the anode current collector ACC. Alternatively, and/or optionally, in some embodiments more than one anode material (AM) can be casted on the anode current collector ACC (e.g., a first anode material AM1 can be casted on the anode current collector ACC and then a second anode material AM2 can be casted over the first anode material AM1). After casting, the film F portion that has been attached to the current collector via weak bonds (WB) may be removed to expose the collector surface. FIG. 7C shows the anode current collector ACC with the casted anode material AM can then be removed from the contoured casting pallet 648 producing an electrode with a consistent electrode coating thickness and an open surface S2 that can be used to make electrical connections when stacking multiple electrochemical cells

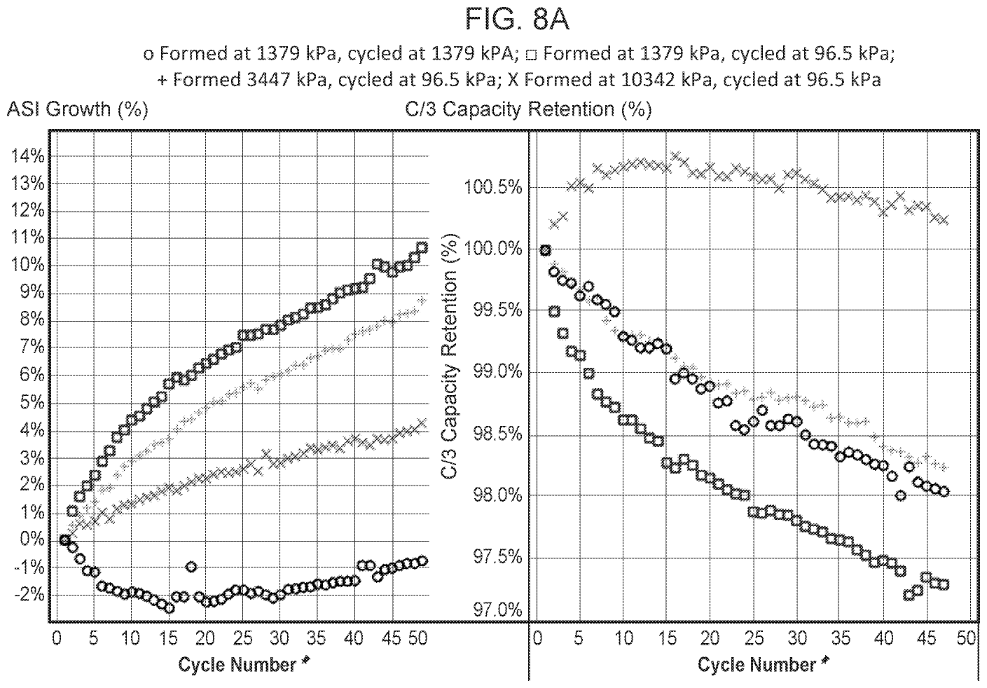

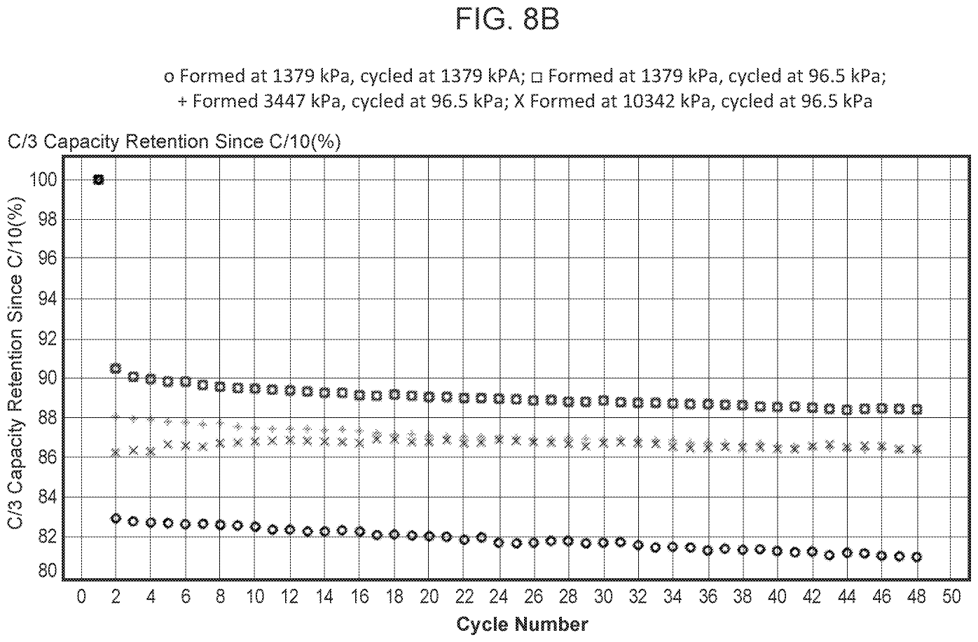

FIGS. 8A-8B show capacity retention of electrochemical cells constructed and operated at various pressures. Each of the cells were constructed with a cathode layer including 50 vol % Lithium-Nickel-Manganese-Cobalt-Oxide (NMC) and 2 vol % Ketjen. Cells were divided into four groups based on cell construction processes. Each of the cells in “Group 1,” “Group 2,” “Group 3,” and “Group 4,” include anodes with one layer of silicon and a second anode layer with a 58 vol % mixture of graphite and C45 carbon black (C45). Cells in Group 1 have an anode that includes one layer of thin film sputtered silicon and a second anode layer with a 58 vol % mixture of graphite and C45. Cells in Group 2 have an anode that includes one layer of thin film sputtered silicon and a second anode layer with a 58 vol % mixture of graphite and C45. After assembling the separator on the second anode layer and the cathode layer, the cells in Group 2 are densified with a pressure of about 25,000 kPa. Cells in Group 3 have an anode that includes one layer of thin film sputtered silicon and a second anode layer with a 58 vol % mixture of graphite and C45. After assembling the separator on the second anode layer and the cathode layer, the assembly in Group 3 is heat-treated for up to about 10 hours. Cells in Group 4 have an anode that includes one layer of wet-coated blend of silicon, SBR/CMC-based binder, and carbon additive and a second anode layer with a 58 vol % mixture of graphite and C45.

FIG. 8A depicts the areal specific impedance (ASI) growth rate and capacity retention during cycling, represented as percentages relative to the first C/3 cycle. Cells that underwent formation at 1,379 kPa and cycled at 1,379 kPa are indicated with circles. Cells that underwent formation at 1,379 kPa and cycled at 96.5 kPa are indicated with squares. Cells that underwent formation at 3,447 kPa and cycled at 96.5 kPa are indicated with plus signs. Cells that underwent formation at 10,342 kPa and cycled at 96.5 kPa are indicated with “x” symbols. As shown in FIG. 8A, the general trend is for higher ASI growth for cells cycled at 96.5 kPa but the ASI growth rate is reduced as the formation pressure is increased. The general trend shows increased capacity retention relative to the first C/3 cycle as the formation pressure is increased to 3,447 kPa and 10,342 kPa.

FIG. 8B depicts the C/3 capacity retention relative to an initial C/10 cycle, represented as a percentage of the C/10 capacity. The drop in capacity is decreased for cells with high formation pressure, improving the rate capability of the cell. The reduction in capacity is decreased for cells with high formation pressure, improving the rate capability of the cell. In FIG. 8B, the cells with formation and cycling at 1,379 kPa show about 82% retention relative to the C/10 cycle. In contrast, cells with 96.5 kPa cycling pressure and 1,379 kPa, 3,447 kPa, and 10,342 kPa formation pressures show 90%, 88%, and 86% capacity retention, respectively, relative to the C/10 cycle. Without wishing to be bound by any particular theory, the mechanism for this trend can be that lower pressure cycling allows for better rate capability of the silicon anode layer. The increased formation pressure helps to improve internal resistance by improving contact resistance between the silicon anode layer and the graphite anode layer, with some decreased capacity as a result of high compaction of the graphite layer.

Table 1 shows a comparison of specific power during a 30-second 1C pulse and the internal resistance (IR) during the pulse. In each of Group 2, Group 3, and Group 4, the cells formed at higher pressures generally have lower IR. This lower IR helps to improve the rate capability, or the trend of capacity retention versus cycling rate. Each of the cells were formed with NMC811 cathodes (60 vol % solid loading) and graphite anodes with carbon additive and 73.4 vol % solid loading.

TABLE 1
Cycling Performance of Cells formed at Various Pressures

| | | | 30 s 1 C | Discharge |
|---|---|---|---|---|
| | Formation | Cycling | Pulse | IR |
| Design | Pressure | Pressure | Power | Drop |
| Group | (kPa) | (kPa) | (W/kg) | (V) |
| Group 2 | 1,379 | 1,379 | 304 | 0.163 |
| Group 2 | 1,379 | 96.5 | 291 | 0.230 |
| Group 2 | 3,447 | 96.5 | 291 | 0.161 |
| Group 2 | 10,342 | 96.5 | 301 | 0.106 |
| Group 3 | 1,379 | 1,379 | 297 | 0.145 |
| Group 3 | 1,379 | 96.5 | 284 | 0.196 |
| Group 3 | 3,447 | 96.5 | 292 | 0.117 |
| Group 3 | 10,342 | 96.5 | 305 | 0.095 |
| Group 4 | 1,379 | 1,379 | 316 | 0.106 |
| Group 4 | 1,379 | 96.5 | 325 | 0.148 |
| Group 4 | 3,447 | 96.5 | 347 | 0.103 |
| Group 4 | 10,342 | 96.5 | 311 | 0.096 |

During charging of the electrochemical cell, the silicon anode layer alloys with lithium to form lithiated silicon (LiₓSi). As the lithium concentration in the lithiated silicon alloy increases, the alloy can expand in volume by up to about 300%. Due to this high volume expansion of the silicon anode layer during charging, contact separation of the graphite anode layer and the silicon anode layer can occur as the lithium concentration in the lithiated silicon alloy decreases during discharging. In other dual anode systems where the graphite anode layer and the silicon anode layer both include adhesive polymer binders, this contact separation is a less significant issue than for semi-solid graphite. This exaggerated contact separation for semi-solid graphite allows for continual buildup of SEI products at the interface between the silicon anode layer and the graphite anode layer during cycling, leading to high ASI growth rate and high internal resistance of the electrochemical cell.

High pressure cycling of the dual anode layer can reduce the contact separation between the graphite anode layer and the silicon anode layer, leading to low ASI growth rate. This high pressure limits the lithium concentration in the lithiated silicon alloy and limits the extent of contact separation during discharging as a result. The disadvantage of high-pressure cycling is not only limited to the decreased capacity of silicon at a higher cycling rate, but also to the increased weight, volume, and cost of packaging required for the cell to maintain such a pressure.

High pressure formation with low pressure cycling for a dual anode containing a semi-solid graphite anode layer and a silicon anode layer can enable lower ASI growth and improved capacity retention at low pressure cycling compared to high pressure cycling. This ASI growth rate improvement at higher formation pressures can be attributed at least in part to improved interfacial contact during formation and improved mechanical integrity of the SEI at the interface of the silicon anode layer and graphite anode layer leading to improved electrochemical SEI passivation at the interface. The rate capability improvement can also be attributed to the lower internal resistance of the cell. The high pressure imposed on the semi-solid graphite anode layer reduces cell internal resistance by improving the contact area through rearrangement of the semi-solid particle suspension of the graphite anode layer at the interface of the graphite anode layer and the silicon anode layer. This contact area improvement eliminates void spaces and/or gas bubbles at the interface between the semi-solid graphite anode layer and the silicon anode layer. By this contact area improvement, the SEI formed at the interface and buildup of internal resistance between the graphite node layer and the silicon anode layer will be substantially decreased by preventing excessive SEI formation in the regions where gas bubbles and void spaces exist.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisional s, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A method, comprising:
disposing a cathode material onto a cathode current collector to form a cathode;
disposing an anode material onto an anode current collector to form an anode; and
disposing the anode and the cathode into an assembly jig with a separator positioned between the anode and the cathode to form an electrochemical cell, the assembly jig applying a force to the electrochemical cell such that a pressure in the cathode material is at least about 3,500 kPa.

2. The method of claim 1, wherein the anode material is a first anode material, the method further comprising:
disposing a second anode material onto the first anode material.

3. The method of claim 2, wherein the first anode material includes silicon.

4. The method of claim 3, wherein the second anode material includes graphite.

5. The method of claim 1, wherein the assembly jig applies a force to the electrochemical cell such that a pressure in the cathode material is at least about 7,000 kPa.

6. The method of claim 5, wherein the assembly jig applies a force to the electrochemical cell such that a pressure in the cathode material is at least about 8,000 kPa.

7. The method of claim 1, further comprising:
applying heat to the electrochemical cell in an amount sufficient to vaporize binder that has migrated to at least one of an interface between the cathode material and the cathode current collector or an interface between the anode material and the anode current collector.

8. The method of claim 2, further comprising:
applying heat to the electrochemical cell in an amount sufficient to vaporize binder that has migrated to an interface between the first cathode material and the second cathode material.

9. The method of claim 8, wherein the heat is applied via at least one of a Nd:YAG laser, a CO₂ laser, electron beam irradiation, plasma, corona, deep UV, etching, infrared, a hot plate, a hot roll, steaming, sputtering, Cu/C sputtering, or direct fire burning.

10. The method of claim 1, wherein the assembly jig applies the force via an air-to-hydraulic multiplier and a hydraulic ram.

11. A method, comprising:
placing an anode, a cathode, and a separator in contact with a first plate of an assembly jig such that at least one of the anode or the cathode contacts the first plate;
placing a second plate in contact with at least one of the anode and the cathode
placing a plurality of springs in contact with the second plate; and
fastening a third plate to the first plate, such that the third plate contacts the plurality of springs, causing the plurality of springs to press against the second plate, such that the second plate presses against the anode, the cathode, and the separator with such a force that a pressure in the cathode is at least about 3,500 kPa.

12. The method of claim 11, wherein the anode includes a first anode material and a second anode material.

13. The method of claim 11, wherein the first plate is positioned below the second plate, and the second plate is a positioned below the third plate.

14. The method of claim 11, wherein the second plate and the third plate each include indentations and the plurality springs are nested in the plurality of indentations.

15. The method of claim 11, further comprising:
applying heat to the anode and the cathode in an amount sufficient to vaporize binder that has migrated to interfaces between electrode material and current collectors of the anode and the cathode.

16. The method of claim 15, wherein the heat is applied via at least one of a Nd:YAG laser, a CO₂ laser, electron beam irradiation, plasma, corona, deep UV, etching, infrared, a hot plate, a hot roll, steaming, sputtering, Cu/C sputtering, or direct fire burning.

17. The method of claim 11, wherein the fastening produces a pressure in the cathode of at least about 7,000 kPa.

18. An assembly jig for assembly of electrochemical cells, comprising:
a first plate configured to contact at least one of an anode or a cathode;
a second plate configured to contact at least one of the anode or the cathode;
a third plate;
a plurality of fasteners coupling the third plate to the first plate; and
a force member between the second plate and the third plate, the force member configured to impart a force upon the second plate and the anode, the cathode, and a separator disposed between the anode and the cathode

19. The assembly jig of claim 18, wherein the force member includes a plurality of springs.

20. The assembly jig of claim 19, wherein the second plate and the third plate each include a plurality of indentations and the plurality of springs are nested in the plurality of indentations.

21. The assembly jig of claim 18, wherein the second plate is positioned above the first plate and the third plate is positioned above the second plate.

22. The assembly jig of claim 18, wherein the second plate is positioned under the first plate and the third plate is positioned under the second plate, and the force member includes an air-to-hydraulic multiplier and a hydraulic ram positioned between the third plate and the second plate, the air-to-hydraulic multiplier and the hydraulic ram configured to impart an upward force on the second plate.

23. The assembly jig of claim 18, wherein the plurality of fasteners are threaded to the first plate and the third plate and the plurality of fasteners pass through unthreaded holes in the second plate.
